(19) United States
(12) Patent Application Publication
(10) Pub. No.: US 2016/0209211 A1
(43) Pub. Date: Jul. 21, 2016

(54) METHOD FOR DETERMINING MISALIGNMENT OF AN OBJECT SENSOR

(71) Applicant: GM GLOBAL TECHNOLOGY OPERATIONS LLC, Detroit, MI (US)

(72) Inventors: Xiaofeng Frank Song, Novi, MI (US); Xian Zhang, Wixom, MI (US); Shuqing Zeng, Sterling Heights, MI (US)

(21) Appl. No.: 14/598,894

(22) Filed: Jan. 16, 2015

(51) Int. Cl. G01B 21/24

(52) U.S. Cl. CPC G01B 21/24

(57) ABSTRACT

A vehicle system and method that can determine object sensor misalignment while a host vehicle is being driven, and can do so within a single sensor cycle through the use of stationary and moving target objects and does not require multiple sensors with overlapping fields of view. In an exemplary embodiment where the host vehicle is traveling in a generally straight line, one or more object misalignment angle(s) αₒ between an object axis and a sensor axis are calculated and used to determine the actual sensor misalignment angle α.

### FIELD

The present invention generally relates to object sensors and, more particularly, to vehicle-mounted object sensors that can detect external objects while the vehicle is driving.

### BACKGROUND

Vehicles are increasingly using different types of object sensors, such as those based on RADAR, LIDAR and/or cameras, to gather information regarding the presence and position of external objects surrounding a host vehicle. It is possible, however, for an object sensor to become somewhat misaligned or skewed such that it provides inaccurate sensor readings. For instance, if a host vehicle is involved in a minor collision, this can unknowingly disrupt the internal mounting or orientation of an object sensor and cause it to provide inaccurate sensor readings. This can be an issue if the erroneous sensor readings are then provided to other vehicle modules (e.g., a safety control module, an adaptive cruise control module, an automated lane change module, etc.) and are used in their computations.

### SUMMARY

According to one embodiment, there is provided a method for determining misalignment of an object sensor on a host vehicle. The method may comprise the steps: determining if the host vehicle is traveling in a straight line; receiving object sensor readings from the object sensor, and obtaining object parameters from the object sensor readings for at least one object in the object sensor field of view; when the host vehicle is traveling in a straight line, using the object parameters to calculate an object misalignment angle αₒ between an object axis and a sensor axis for the at least one object; and using the object misalignment angle αₒ to determine a sensor misalignment angle α.

According to another embodiment, there is provided a method for determining misalignment of an object sensor on a host vehicle. The method may comprises the steps: determining if the host vehicle is traveling in a straight line; receiving object sensor readings from the object sensor, and obtaining object parameters from the object sensor readings for at least one object in the object sensor field of view; determining if the at least one object is a valid object; when the host vehicle is traveling in a straight line and the at least one object is a valid object, using the object parameters to calculate an object misalignment angle αₒ between an object axis and a sensor axis for the at least one valid object; using the object misalignment angle αₒ to establish a long term misalignment angle αₗₜ; and using the long term misalignment angle αₗₜ to determine a sensor misalignment angle α.

According to another embodiment, there is provided a vehicle system on a host vehicle. The vehicle system may comprise: one or more vehicle sensors providing vehicle sensor readings, the vehicle sensor readings indicate whether or not the host vehicle is traveling in a straight line; one or more object sensors providing object sensor readings, wherein the object sensor readings include object parameters for at least one object in an object sensor field of view; and a control module being coupled to the one or more vehicle sensors for receiving the vehicle sensor readings and being coupled to the one or more object sensors for receiving the object sensor readings. The control module may be configured to use the object parameters to calculate an object misalignment angle αₒ for the at least one object, the object misalignment angle αₒ being defined by an object axis and a sensor axis, and using the object misalignment angle αₒ to determine a sensor misalignment angle α.

### DRAWINGS

Preferred exemplary embodiments will hereinafter be described in conjunction with the appended drawings, wherein like designations denote like elements, and wherein:

FIG. 1 is a schematic view of a host vehicle having an exemplary vehicle system;

FIG. 2 is a flowchart illustrating an exemplary method for determining object sensor misalignment and may be used with a vehicle system, such as the one shown in FIG. 1;

FIG. 3 is a schematic view of a sensor field of view for an object sensor that may be used with a vehicle system, such as the one shown in FIG. 1;

FIG. 4 is a schematic view illustrating a potential embodiment of how object sensor misalignment may be estimated by a vehicle system, such as the one shown in FIG. 1; and

FIGS. 5-7 are graphs that illustrate test results of one embodiment of the disclosed system and method.

### DESCRIPTION

The exemplary vehicle system and method described herein may determine misalignment of an object sensor while a host vehicle is being driven, and may do so with readings obtained in one sensor cycle, thereby reducing the amount of data that needs to be stored and resulting in a more instantaneous determination of misalignment. The method may also take into account certain moving objects instead of only determining misalignment based on the presence and relative location of stationary objects, resulting in a more comprehensive estimation of misalignment. If a misalignment is detected, the vehicle system and method can send a corresponding notification to the user, the vehicle, or to some other source indicating that there is a sensor misalignment that should be fixed. This may be particularly advantageous in circumstances where other vehicle modules—for instance, a safety control module, an adaptive cruise control module, an automated lane change module, etc.—depend on and utilize the output of the misaligned object sensor. The method and system may be able to compensate for a detected misalignment until the object sensor is fixed.

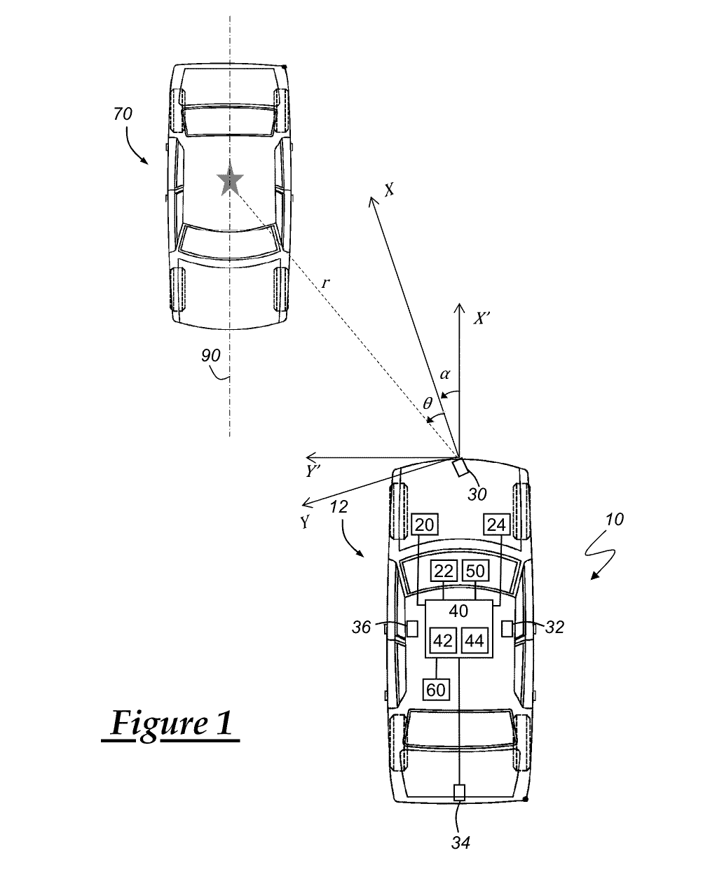

In an exemplary embodiment where the host vehicle is traveling in a straight line, the present method uses object parameters from object sensor readings to calculate an object misalignment angle αₒ for an individual valid object in one sensor cycle. If multiple valid objects are detected while the host vehicle is traveling in a straight line, the method may use multiple object misalignment angles αₒ to calculate a cycle misalignment angle α_{c} based on readings obtained in a single sensor cycle. According to one particular embodiment, the method may use cycle misalignment angles α_{c} from more than one sensor cycle to establish a long term misalignment angle αₗₜ. The object misalignment angle αₒ, the cycle misalignment angle α_{c}, and/or the long term misalignment angle αₗₜ may be used to determine the actual sensor misalignment angle α depicted in FIG. 1. Each of the aforementioned misalignment angles will be subsequently described in more detail. The method is designed to be iterative such that the long term misalignment angle αₗₜ estimation becomes more accurate and precise over time. The various embodiments of the method and system described herein may result in improved object detection accuracy and reliability, and may do so within a single sensor cycle or multiple sensor cycles.

With reference to FIG. 1, there is shown a general and schematic view of an exemplary host vehicle 10 with a vehicle system 12 installed or mounted thereon, where the vehicle system includes one or more object sensors that may over time become skewed or misaligned by angle α with respect to their intended orientation. It should be appreciated that the present system and method may be used with any type of vehicle, including traditional passenger vehicles, sports utility vehicles (SUVs), cross-over vehicles, trucks, vans, buses, recreational vehicles (RVs), etc. These are merely some of the possible applications, as the system and method described herein are not limited to the exemplary embodiments shown in the figures and could be implemented in any number of different ways. According to one example, vehicle system 12 includes vehicle sensors 20 (e.g., inertial measurement unit (IMU), steering angle sensor (SAS), wheel speed sensors, etc.), a turn signal switch 22, a navigation module 24, object sensors 30-36, and a control module 40, and the vehicle system may provide a user with a notification or other sensor status information via a user interface 50 or some other component, device, module and/or system 60.

Any number of different sensors, components, devices, modules, systems, etc. may provide vehicle system 12 with information or input that can be used by the present method. These include, for example, the exemplary sensors shown in FIG. 1, as well as other sensors that are known in the art but are not shown here. It should be appreciated that vehicle sensors 20, object sensors 30-36, as well as any other sensor located in and/or used by vehicle system 12 may be embodied in hardware, software, firmware or some combination thereof. These sensors may directly sense or measure the conditions for which they are provided, or they may indirectly evaluate such conditions based on information provided by other sensors, components, devices, modules, systems, etc. Furthermore, these sensors may be directly coupled to control module 40, indirectly coupled via other electronic devices, a vehicle communications bus, network, etc., or coupled according to some other arrangement known in the art. These sensors may be integrated within or be a part of another vehicle component, device, module, system, etc. (e.g., vehicle or object sensors that are already a part of an engine control module (ECM), traction control system (TCS), electronic stability control (ESC) system, antilock brake system (ABS), safety control system, automated driving system, etc.), they may be stand-alone components (as schematically shown in FIG. 1), or they may be provided according to some other arrangement. It is possible for any of the various sensor readings described below to be provided by some other component, device, module, system, etc. in host vehicle 10 instead of being provided by an actual sensor element. It should be appreciated that the foregoing scenarios represent only some of the possibilities, as vehicle system 12 is not limited to any particular sensor or sensor arrangement.

Vehicle sensors 20 provide vehicle system 12 with various readings, measurements, and/or other information that may be useful to method 100. For example, vehicle sensors 20 may measure: wheel speed, wheel acceleration, vehicle speed, vehicle acceleration, vehicle dynamics, yaw rate, steering angle, longitudinal acceleration, lateral acceleration, or any other vehicle parameter that may be useful to method 100. Vehicle sensors 20 may utilize a variety of different sensor types and techniques, including those that use rotational wheel speed, ground speed, accelerator pedal position, gear shifter selection, accelerometers, engine speed, engine output, and throttle valve position, to name a few. Skilled artisans will appreciate that these sensors may operate according to optical, electromagnetic and/or other technologies, and that other parameters may be derived or calculated from these readings (e.g., acceleration may be calculated from velocity). According to an exemplary embodiment, vehicle sensors 20 include some combination of a vehicle speed sensor, a vehicle yaw rate sensor, and a steering angle sensor.

Turn signal switch 22 is used to selectively operate the turn signal lamps of host vehicle 10 and provides the vehicle system 12 with turn signals that indicate a driver's intent to turn, change lanes, merge and/or otherwise change the direction of the vehicle. If the turn signal switch 22 is activated, it generally serves as an indication that the driver of the host vehicle intends to turn, change lanes, or merge, or is in the process of doing so. If the turn signal switch 22 is not activated, it generally serves as an indication that the driver of the host vehicle does not intend to turn, change lanes, or merge. While the activation of the turn signal switch may not always be entirely indicative of the driver's intention, it may be used as an additional piece of information in the method 100 to confirm whether the vehicle is traveling in a straight line. In other words, there may be scenarios where the driver fails to activate the turn signal switch 22, yet turns anyway. In such scenarios, information from vehicle sensors 20 may override the non-activation status of turn signal switch 22 and indicate that the vehicle is not traveling in a straight line.

Navigation unit 24 may be used to provide the vehicle system 12 with navigation signals that represent the location or position of the host vehicle 10. Depending on the particular embodiment, navigation unit 24 may be a stand-alone component or it may be integrated within some other component or system within the vehicle. The navigation unit may include any combination of other components, devices, modules, etc., like a GPS unit, and may use the current position of the vehicle and road- or map-data to evaluate the upcoming road. For instance, the navigation signals or readings from unit 24 may include the current location of the vehicle and information regarding the configuration of the current road segment and the upcoming road segment (e.g., upcoming turns, curves, forks, embankments, straightaways, etc.). The navigation unit 24 can store pre-loaded map data and the like, or it can wirelessly receive such information through a telematics unit or some other communications device, to cite two possibilities.

Object sensors 30-36 provide vehicle system 12 with object sensor readings and/or other information that relates to one or more objects around host vehicle 10 and can be used by the present method. In one example, object sensors 30-36 generate object sensor readings indicating one or more object parameters including, for example, the presence and coordinate information of objects around host vehicle 10, such as the objects' range, range rate, azimuth, and/or azimuth rate. These readings may be absolute in nature (e.g., an object position reading) or they may be relative in nature (e.g., a relative distance reading, which relates to the range or distance between host vehicle 10 and some object). Each of the object sensors 30-36 may be a single sensor or a combination of sensors, and may include a light detection and ranging (LIDAR) device, a radio detection and ranging (RADAR) device, a laser device, a vision device (e.g., camera, etc.), or any other sensing device capable of providing the needed object parameters. According to an exemplary embodiment, object sensor 30 includes a forward-looking, long-range or short-range radar device that is mounted on the front of the vehicle, such as at the front bumper, behind the vehicle grille, or on the windshield, and monitors an area in front of the vehicle that includes the current lane plus one or more lanes on each side of the current lane. Similar types of sensors may be used for rearward-looking object sensor 34 mounted on the rear of the host vehicle, such as at the rear bumper or in the rear window, and for lateral or sideward-looking object sensors 32 and 36 mounted on each side of the vehicle (e.g., passenger and driver sides). A camera or other vision device could be used in conjunction with such sensors, as other embodiments are also possible.

Control module 40 may include any variety of electronic processing devices, memory devices, input/output (I/O) devices, and/or other known components, and may perform various control and/or communication related functions. In an exemplary embodiment, control module 40 includes an electronic memory device 42 that stores various sensor readings (e.g., sensor readings from sensors 20 and 30-36), look up tables or other data structures, algorithms (e.g., the algorithm embodied in the exemplary method described below), etc. Memory device 42 may also store pertinent characteristics and background information pertaining to host vehicle 10, such as information relating to expected sensor mounting or orientation, sensor range, sensor field-of-view, etc. Control module 40 may also include an electronic processing device 44 (e.g., a microprocessor, a microcontroller, an application specific integrated circuit (ASIC), etc.) that executes instructions for software, firmware, programs, algorithms, scripts, etc. that are stored in memory device 42 and may govern the processes and methods described herein. Control module 40 may be electronically connected to other vehicle devices, modules and systems via suitable vehicle communications and can interact with them when required. These are, of course, only some of the possible arrangements, functions and capabilities of control module 40, as other embodiments could also be used.

Depending on the particular embodiment, control module 40 may be a stand-alone vehicle module (e.g., an object detection controller, a safety controller, an automated driving controller, etc.), it may be incorporated or included within another vehicle module (e.g., a safety control module, an adaptive cruise control module, an automated lane change module, a park assist module, a brake control module, a steering control module, etc.), or it may be part of a larger network or system (e.g., a traction control system (TCS), electronic stability control (ESC) system, antilock brake system (ABS), driver assistance system, adaptive cruise control system, lane departure warning system, etc.), to name a few possibilities. Control module 40 is not limited to any one particular embodiment or arrangement.

User interface 50 exchanges information or data with occupants of host vehicle 10 and may include any combination of visual, audio and/or other types of components for doing so. Depending on the particular embodiment, user interface 50 may be an input/output device that can both receive information from and provide information to the driver (e.g., a touch-screen display or a voice-recognition human-machine interface (HMI)), an output device only (e.g., a speaker, an instrument panel gauge, or a visual indicator on the rear-view mirror), or some other component. User interface 50 may be a stand-alone module; it may be part of a rear-view mirror assembly, it may be part of an infotainment system or part of some other module, device or system in the vehicle; it may be mounted on a dashboard (e.g., with a driver information center (DIC)); it may be projected onto a windshield (e.g., with a heads-up display); or it may be integrated within an existing audio system, to cite a few examples. In the exemplary embodiment shown in FIG. 1, user interface 50 is incorporated within an instrument panel of host vehicle 10 and alerts a driver of a misaligned object sensor by sending a written or graphic notification or the like. In another embodiment, user interface 50 sends an electronic message (e.g., a diagnostic trouble code (DTC), etc.) to some internal or external destination alerting it of the sensor misalignment. Other suitable user interfaces may be used as well.

Module 60 represents any vehicle component, device, module, system, etc. that requires a sensor reading from one or more object sensors 30-36 in order to perform its operation. To illustrate, module 60 could be an active safety system, an adaptive cruise control (ACC) system, an automated lane change (LCX) system, or some other vehicle system that uses sensor readings relating to nearby vehicles or objects in order to operate. In the example of an adaptive cruise control (ACC) system, control module 40 may provide ACC system 60 with a warning to ignore sensor readings from a specific sensor if the present method determines that the sensor is misaligned, as inaccuracies in the sensors readings could negatively impact the performance of ACC system 60. Depending on the particular embodiment, module 60 may include an input/output device that can both receive information from and provide information to control module 40, and it can be a stand-alone vehicle electronic module or it can be part of a larger network or system (e.g., a traction control system (TCS), electronic stability control (ESC) system, antilock brake system (ABS), driver assistance system, adaptive cruise control (ACC) system, lane departure warning system, etc.), to name a few possibilities. It is even possible for module 60 to be combined or integrated with control module 40, as module 60 is not limited to any one particular embodiment or arrangement.

Again, the preceding description of exemplary vehicle system 12 and the drawing in FIG. 1 are only intended to illustrate one potential embodiment, as the following method is not confined to use with only that system. Any number of other system arrangements, combinations, and architectures, including those that differ significantly from the one shown in FIG. 1, may be used instead.

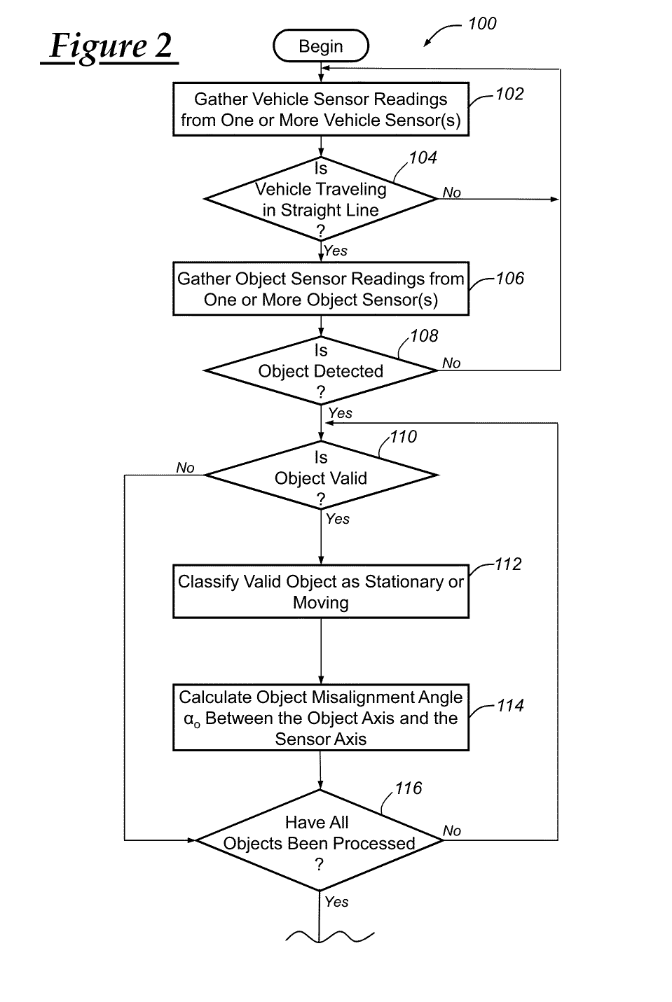

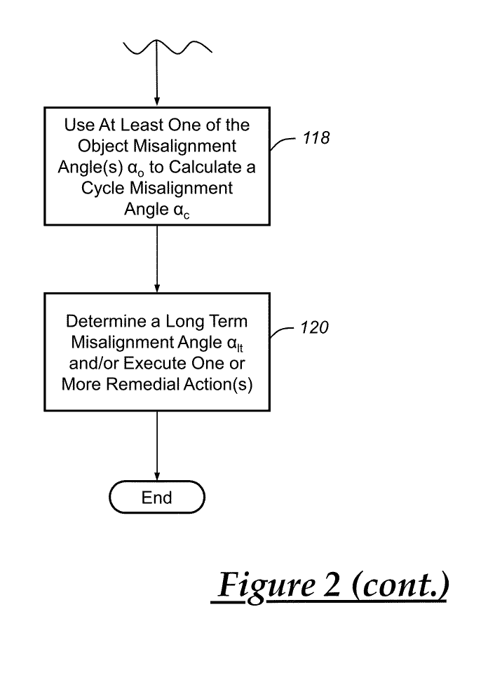

Turning now to FIG. 2, there is shown an exemplary method 100 that may be used with vehicle system 12 in order to determine if one or more object sensors 30-36 are misaligned, skewed or otherwise oriented improperly. As mentioned above, an object sensor may become misaligned as a result of a collision, a significant pothole or other disruption in the road surface, or just through the normal wear and tear of years of vehicle operation, to name a few possibilities. Method 100 may be initiated or started in response to any number of different events and can be executed on a periodic, aperiodic and/or other basis, as the method is not limited to any particular initialization sequence. According to some non-limiting examples, method 100 can be continuously running in the background, it can be initiated following an ignition event, or it may be started following a collision, to cite several possibilities.

Beginning with step 102, the method gathers vehicle sensor readings from one or more vehicle sensors 20. The gathered vehicle sensor readings may provide information relating to: wheel speed, wheel acceleration, vehicle speed, vehicle acceleration, vehicle dynamics, yaw rate, steering angle, longitudinal acceleration, lateral acceleration, and/or any other suitable vehicle operating parameter. In one example, step 102 obtains vehicle speed readings that indicate how fast the host vehicle is moving and yaw rate readings and/or other readings that indicate whether or not host vehicle 10 is traveling in a straight line. Steering angle readings and navigation signals may also be used to indicate whether or not the host vehicle 10 is traveling in a straight line. Skilled artisans will appreciate that step 102 may gather or otherwise obtain other vehicle sensor readings as well, as the aforementioned readings are only representative of some of the possibilities.

Step 104 then determines if host vehicle 10 is moving or traveling in a straight line. When the host vehicle is traveling in a straight line—for example, across some stretch of highway or other road—certain assumptions can be made that simplify the calculations performed by method 100 and thereby make the corresponding algorithm lighter weight and less resource intensive. In an exemplary embodiment, step 104 evaluates the vehicle sensor readings from the previous step (e.g., yaw rate readings, wheel speed readings, steering angle readings, etc.) and uses this information to determine if host vehicle 10 is by-and-large moving in a straight line. This step may require the steering angle or yaw rate to be less than some predetermined threshold for a certain amount of time or distance, or it may require the various wheel speed readings to be within some predetermined range of one another, or it may use other techniques for evaluating the linearity of the host vehicle's path. It is even possible for step 104 to use information from some type of GPS-based vehicle navigation system, such as navigation unit 24, in order to determine if the host vehicle is traveling in a straight line. In one embodiment, if the curve radius of the road is above a certain threshold (e.g., above 1000 m), it can be assumed that the host vehicle is traveling in a straight line. The linear status of the vehicle's path could be provided by some other device, module, system, etc. located in the host vehicle, as this information may already be available. “Traveling in a straight line” means that the host vehicle is traveling on a linear road segment generally parallel to the overall road orientation. In other words, if the host vehicle 10 is merging on the highway, for example, it is not traveling generally parallel to the overall road orientation, yet could technically be considered traveling in a straight line. Another example of when the host vehicle is not traveling in a straight line is when the host vehicle 10 is switching lanes. The method 100 may try to screen out such instances such as merging and switching lanes. In order to screen out such instances, the activation of the turn signal switch 22 by the driver may be used to supplement the readings from the vehicle sensors 20. In accordance with one embodiment, if the turn signal switch 22 is activated, step 104 will determine that the vehicle is not currently traveling in a straight line or will not be moving in a straight line in the near future. In order to constitute “traveling” for purposes of step 104, it may be required that the host vehicle 10 have a speed greater than a speed threshold, such as 5 m/s, for example. If host vehicle 10 is traveling in a straight line, then the method proceeds to step 106; otherwise, the method loops back to the beginning.

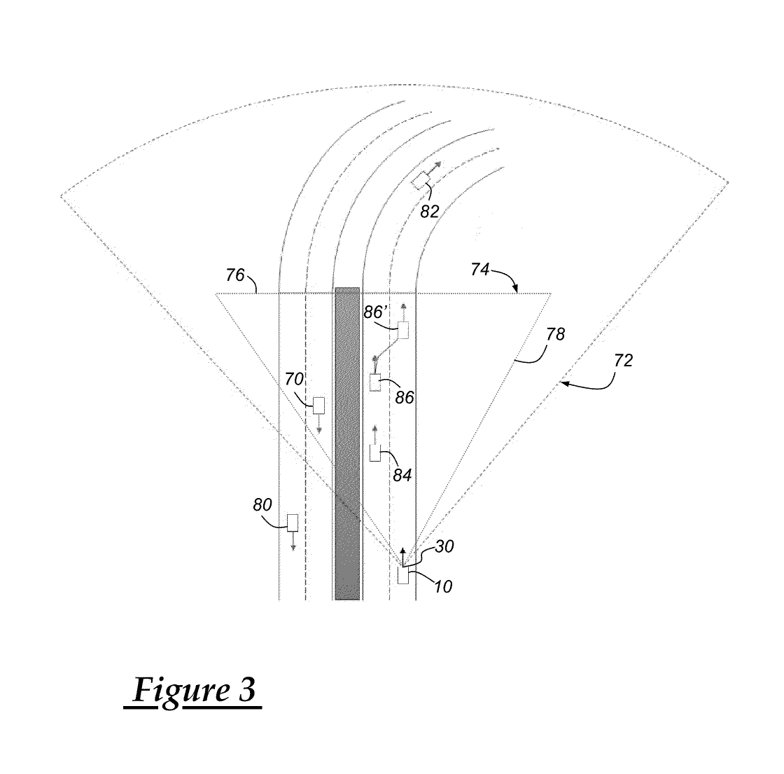

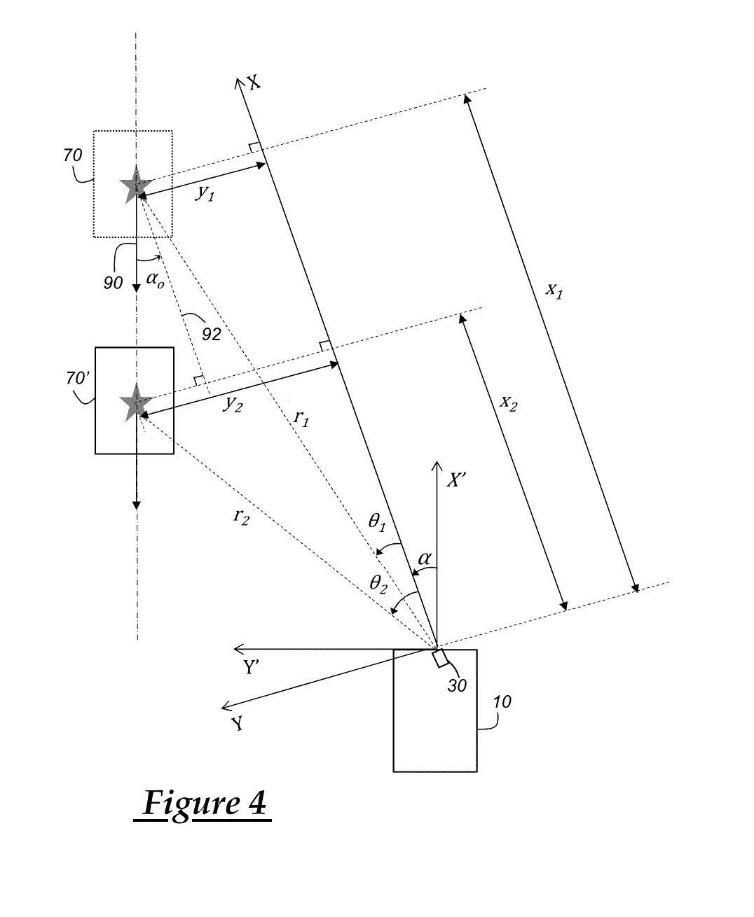

Step 106 gathers object sensor readings from one or more object sensors 30-36 located around the host vehicle. The object sensor readings indicate whether or not an object has entered the field-of-view of a certain object sensor, as will be explained, and may be provided in a variety of different forms. With reference to FIGS. 3 and 4, in one embodiment, step 106 monitors a field of view 72 of object sensor 30, which is mounted towards the front of host vehicle 10. The object sensor 30 has sensor axes X, Y that define a sensor coordinate system (e.g., a polar coordinate system, a Cartesian coordinate system, etc.). In this particular example, the current sensor coordinate system based on axes X, Y has become somewhat misaligned or skewed with respect to the sensor's original orientation, which was based on axes X′, Y′. This misalignment is illustrated in FIG. 4. The following description is primarily directed to a method that uses polar coordinates, but it should be appreciated that any suitable coordinate system or form could be used instead. With particular reference to FIG. 3, the object sensor field of view 72 is typically somewhat pie-shaped and is located out in front of the host vehicle, but the field of view may vary depending on the range of the sensor (e.g., long range, short range, etc.), the type of sensor (e.g., radar, LIDAR, LADAR, laser, etc.), the location and mounting orientation of the sensor (e.g., a front sensor 30, side sensors 32 and 36, rear sensor 34, etc.), or some other characteristic. The object sensor 30 provides the method with sensor readings pertaining to a coordinate and a coordinate rate for one or more target objects, such as target object 70. In a preferred embodiment, the object sensor 30 is a short-range or long-range radar device that provides the method with sensor readings pertaining to a range, a range rate, an azimuth, an azimuth rate, or some combination thereof for one or more objects in the sensor field of view 72, such as target object 70. The precise combination of object parameters and the exact content of the object sensor readings can vary depending on the particular object sensor being used. The present method is not limited to any particular protocol. Step 106 may be combined with step 108 or some other suitable step within the method, as it does not have to be performed separately nor does it have to be performed in any particular order.

Step 108 determines if an object has been detected in the field of view of one or more of the object sensors. According to one example, step 108 monitors the field of view 72 for the forward-looking object sensor 30, and uses any number of suitable techniques to determine if one or more objects have entered the field of view. The techniques employed by this step may vary for different environments (e.g., high object density environments like urban areas may use different techniques than low object density environments like rural areas, etc.). It is possible for step 108 to consider and evaluate multiple objects within the sensor field of view 72 at the same time, both moving and stationary objects, as well as other object scenarios. This step may utilize a variety of suitable filtering and/or other signal processing techniques to evaluate the object sensor readings and to determine whether or not an object really exists. Some non-limiting examples of such techniques include the use of predetermined signal-to-noise ratio (SNR) thresholds in the presence of background noise, as well as other known methods. If step 108 determines that an object is present, then the method proceeds to step 110; otherwise, the method loops back to the beginning for further monitoring.

If an object is detected in step 108, step 110 determines whether the object is valid. The usage of valid objects allows for certain assumptions to be made and can result in a more accurate misalignment detection algorithm. Unlike other sensor misalignment methodologies, valid objects analyzed under the present method 100 may include stationary objects and moving objects. Criteria that may be used to validate target objects include whether the object's rate of change of position or range rate is above a certain range rate threshold, whether the target object is traveling in parallel with relation to the host vehicle, and whether the object is located within a reduced field of view of the object sensor's nominal field of view. More criteria or different criteria may be used in addition to, or instead of, the criteria listed above and described below to determine whether an object is valid.

One criterion used to determine object validity is the object's rate of change of position or range rate \dot{r}. When the object's range rate is above a certain threshold, a more accurate estimation of misalignment may be obtained. If the object's range rate is below a certain threshold, such as when the target object is a vehicle traveling at the same speed in the same direction as the host vehicle, it may result in a skewed estimation of misalignment in certain embodiments. Continuing with this example, if the range rate is low because the target vehicle is traveling at the same speed and in the same direction as the host vehicle, the corresponding azimuth rate would also likely be zero or close to zero, which could cause errors in calculating the misalignment angle. Accordingly, if an object's range rate is greater than a threshold range rate, say for example 2 m/s, then the object may be considered valid. The range rate or the object's rate of change of position may be ascertained from the output of the target sensor or otherwise derived from data pertaining to the object's range.

Another criterion that may be used to determine whether an object is valid includes whether the movement of the object is generally parallel with the movement of the host vehicle. Since it has been determined in step 104 that the host vehicle is traveling in a straight line, it can necessarily be assumed that the host vehicle is moving parallel with relation to stationary objects. However, with moving objects, it is desirable to only consider objects with motion that is parallel relative to the host vehicle as valid objects. This allows certain assumptions to be made based on the trigonometric relationships between the host vehicle and a moving target object. Determining whether a target object is moving parallel with relation to the host vehicle may be accomplished in a number of ways, including but not limited to using host vehicle cameras or visual sensors to determine whether the driver of a target vehicle has activated the turn signal or employing a reduced field of view based on road features such as road curvature, which is described in more detail below.

In accordance with another embodiment, step 110 may determine object validity by analyzing whether the object is present in a reduced field of view. This embodiment is illustrated in FIG. 3. Because it can be difficult to determine whether a moving target object is traveling parallel with relation to the host vehicle, the use of a reduced field of view may assist in screening out target objects that are not traveling parallel with relation to the host vehicle. Further, since erroneous sensor data is more likely at the boundaries of the target sensor's nominal field of view, using a reduced field of view may result in a more accurate estimation of misalignment. With reference to FIG. 3, there is shown the host vehicle 10 having an object sensor 30 with a field of view 72. This particular method of determining validity would classify objects as valid if they are in a reduced field of view 74. The reduced field of view 74 is generally defined by a distance threshold 76 and an angular threshold 78, although it may be possible to only have one threshold, such as a distance threshold only or an angular threshold only. In general, a “reduced field of view” means that the detected object's range and azimuth needs to be within a smaller scope than the nominal sensor field-of-view. The reduced field of view thresholds maybe a static fraction of the original azimuth or range, or may be a dynamic fraction of the original azimuth or range. An example of a static threshold may include when the distance threshold 76 is derived from the sensor parameters. For example, if the sensor can detect objects as far as 100 m, than the distance threshold may be defined as 90 m. The angular threshold may similarly be derived from the object sensor specifications. For example, if the sensor is capable of sensing in a range from −60 to 60 degrees, the angular threshold may be defined as −55 to 55 degrees. Alternatively, as in the illustrated embodiment, the distance threshold 76 can be dynamically defined by the upcoming road geometry, vehicle speed, or other factors. The upcoming road geometry may be determined based on readings from the navigation unit 24, for example, or by readings from the object sensor itself. Curve radius may also be used. For example, if the curve radius is greater than a certain threshold (e.g., 1000 m), it can be assumed that the object is traveling parallel with relation to the host vehicle. Since it is preferable to use objects that are moving parallel to the host vehicle, the omission of upcoming road curves from the reduced field of view can result in a more accurate determination of misalignment. In instances where the road segment is straight for the entire length of the sensor range (e.g., 100 m), the distance threshold may equal the entire length of the sensor range. It should also be noted that the reduced field of view can take numerous different shapes and/or sizes. As an example, the distance threshold 76 may be more arcuate and mimic the shape of the nominal field of view 72. With continued reference to FIG. 3, to accordingly determine object validity, vehicle 80 would not be valid because it is outside of the reduced sensor field of view 74 and the nominal sensor field of view 72; however, it should be understood that vehicle 80 could have been deemed a valid object in previous sensor cycles. Vehicle 82 would not be valid because it is outside of the reduced sensor field of view 74. Vehicles 70, 84 are valid. Vehicle 86 would also be considered a valid object, although it is switching lanes such that it moves in a direction that is not generally parallel with the host vehicle 10. The lane change movement of vehicle 86 may result in a slightly skewed estimation of the misalignment angle, but over the long-term, this effect would be offset by counter-effect object movement (e.g., vehicles switching lanes from right to left). Moreover, by weighting stationary objects more than moving objects and carefully tuning the filter coefficient, which will be described in more detail below, the short term effect of the movement of vehicle 86 may be minimized.

In one embodiment, step 110 may determine or confirm object validity by ensuring the target object's range rate is above a certain threshold and ensuring that the target object is in a reduced field of view. Because the reduced field of view can be defined with relation to the road geometry, this may assist in determining that moving target objects are traveling parallel with relation to the host vehicle. Step 110 may also confirm object validity based on a confidence level or by analyzing whether the object is present in the reduced field of view for a certain number of sensor cycles. Generally, sensors can report one or more properties that are indicative of the confidence level of some real object that is actually being detected. This confidence level may be compared to a threshold to further ensure validity. Similarly, by analyzing whether the object is present in the reduced field of view for a certain number of sensor cycles, such as two or three, the method is able to confirm that the detected object is indeed a real object instead of a ghost target, for example, thereby reducing the risk of misdetection of some non-existent objects.

If it is determined in step 110 that the object is valid, the object is then classified as stationary or moving in step 112. An advantage of the present method is that both stationary objects and moving objects can be used to determine sensor misalignment. In a preferred embodiment, object sensor 30 provides object sensor readings that include an indication as to whether one or more detected objects are stationary or not. This is common for many vehicle-mounted object sensors. In situations where an object sensor is seriously misaligned (e.g., more than 10° off), then the object sensor may not be able to correctly report whether or not an object is stationary. Accordingly, other sensor misalignment detection algorithms that depend solely on the use of stationary objects are only capable of accurately detecting smaller degrees of misalignment (e.g., less than 10°). Thus, the current methodology is capable of detecting both small and large misalignments through the use of stationary and moving objects. If the sensor does not report whether an object is stationary or not, a separate algorithm can be implemented as will be apparent to those skilled in the art. Step 112 is optional and is preferably employed in scenarios where stationary objects are weighted in favor of, or otherwise treated differently than, moving objects. It should further be noted that this step may alternatively come before step 110 or after later steps in the method.

At this point in the method, vehicle sensor readings have been gathered to determine that the host vehicle is traveling in a straight line, and may also be used to ensure a valid target object is being analyzed. Object sensor readings have been gathered, which include object parameters such as a coordinate and a coordinate rate for a valid target object. In one embodiment, stationary target objects and moving target objects are classified separately. This information may be used to determine the sensor misalignment angle α, as shown in FIG. 1. To determine the sensor misalignment angle α, at least one object misalignment angle αₒ, which generally corresponds to the sensor misalignment angle α, is calculated. The object misalignment angle αₒ may be used to establish a cycle misalignment angle α_{c} that takes into account one or more object misalignment angles αₒ in one particular sensor cycle, or a long term misalignment angle αₗₜ which takes into account misalignment angles over multiple sensor cycles.

Step 114 involves calculating the object misalignment angle αₒ between an object axis and a sensor axis. With reference to FIGS. 1 and 4, it is shown that the object sensor 30, which should be mounted in conjunction with the host vehicle axes X′, Y′, has become skewed such that there is a misalignment angle α which is generally defined as the angular difference between the object sensor axes X, Y, and the host vehicle axes X′, Y′. If the object sensor is typically mounted at a different angle (e.g., the object sensor is purposely mounted at a 30° angle with respect to the host vehicle axes X′, Y′), this can be compensated for, but compensation is not necessarily needed for a different mounting location. With particular reference to FIG. 4, the sensor misalignment angle α corresponds to the object misalignment angle αₒ through certain trigonometric relationships when the object axis 90 is generally parallel to the host vehicle axis X′. Accordingly, the misalignment angle for the object αₒ can be used as an estimate for the misalignment angle of the sensor α.

In one embodiment, the target object 70 is detected by the object sensor 30 of the host vehicle and object parameters such as a range r, a range rate \dot{r}, an azimuth θ, and an azimuth rate \dot{θ} of the target object 70 are obtained. If the azimuth rate \dot{θ} is not reported by the sensor, it can be derived, which is explained in further detail below. The range r, the range rate \dot{r}, the azimuth θ, and the azimuth rate \dot{θ} of the target object 70 can be used to calculate the object misalignment angle αₒ between the target object's axis 90 and the sensor axis 92. The object axis 90 generally corresponds to the velocity direction of the target object with relation to the host vehicle, and the sensor axis includes axes parallel to the X axis of the sensor and going through the target object 70, such as sensor axis 92. Since the host vehicle 10 and the target 70 are presumed to be traveling in parallel straight lines, if the object sensor 30 was not misaligned, the object misalignment angle αₒ would equal 0°. In a preferred embodiment, the object misalignment angle αₒ is calculated in accordance with the following equation:

$${α}_{o} = a tan ( - \frac{\dot{r} sin θ + r cos θ \dot{θ}}{\dot{r} cos θ - r sin θ \dot{θ}} )$$

where r is the range, \dot{r} is the range rate, θ is the azimuth, and \dot{θ} is the azimuth rate of the target object 70, with the various object parameters being measured, calculated, and/or reported in radians.

With continued reference to FIG. 4, the above equation can be derived because in normal operation, the object sensor 30 reports positions (r₁, θ₁) at time t₁ for the target object 70, and (r₂, θ₂) at time t₂ for the target object 70′ as the target object moves parallel relative to the host vehicle 10. Alternatively, the object sensor 30 may report positions (x₁, y₁) for the object 70 and (x₁, y₁) for the object 70′ in a Cartesian coordinate system where

$$[ \begin{matrix}x \\ y\end{matrix} ] = [ \begin{matrix}r cos θ \\ r sin θ\end{matrix} ] .$$

Thus, in accordance with one embodiment, the equation above for the misalignment angle for the object αₒ can be derived as follows:

$${α}_{o} = a tan ( tan {α}_{o} ) = a tan ( \frac{{y}_{2} - {y}_{1}}{{x}_{1} - {x}_{2}} ) = a tan ( - \frac{{r}_{2} sin {θ}_{2} - {r}_{1} sin {θ}_{1}}{{r}_{2} cos {θ}_{2} - {r}_{1} cos {θ}_{1}} ) = a tan ( - \frac{\frac{d }{d t} ( r sin θ )}{\frac{d }{d t} ( r cos θ )} )$$

$${α}_{o} = a tan ( - \frac{\dot{r} sin θ + r cos θ \dot{θ}}{\dot{r} cos θ - r sin θ \dot{θ}} )$$

As mentioned, it is preferable that the object sensor 30 reports the range r, the range rate \dot{r}, the azimuth θ, and the azimuth rate \dot{θ} of valid target objects. However, if the azimuth rate \dot{θ}, which is the rate of change of the azimuth angle, is not provided by the object sensor, it can be derived. Any suitable method may be used to derive the azimuth rate \dot{θ}. In one example, to derive the azimuth rate \dot{θ}, the target object must be present for two or more sensor cycles. If the sensor reports using object IDs and tracks, it may be desirable to associate tracks by matching the object ID to data reported in a previous cycle because objects may not stay in the same track while it is present in the sensor field of view. Once it is confirmed that the same valid object is being tracked, if so desired, the valid object will have an azimuth θₖ for the present sensor cycle and an azimuth θₖ₋₁ for a previous sensor cycle. The azimuth rate \dot{θ} can then be calculated with the following equation, for example, and used in step 114 to calculate the object misalignment angle αₒ:

$${\dot{θ}}_{k} = \frac{{θ}_{k} - {θ}_{k - 1}}{Δ T}$$

where θₖ is the azimuth for the current sensor cycle, θₖ₋₁ is the azimuth for a previous sensor cycle, and ΔT is the time interval between the current sensor cycle and the previous sensor cycle.

Once an object misalignment angle αₒ is calculated in step 114, the method asks in step 116 whether all the objects have been processed. For example, with reference to FIG. 3, if the method has calculated a misalignment angle for target object 70 only, the method will return back to step 110 for each remaining object 82, 84, 86. Object 80 is not detected in the sensor field of view 72 in the depicted sensor cycle and will not be evaluated (although it was likely previously analyzed assuming the methodology was being performed while the target vehicle 80 was in the sensor field of view). Accordingly, object misalignment angles αₒ will be calculated for target objects 84 and 86, but not 82 since 82 is not a valid object, as already explained. It should be noted that upon each sensor cycle of the methodology, a new object misalignment angle αₒ may be calculated for a given object, and this depends on how long the object is in the object sensor field of view or reduced field of view. Once all the objects have had an object misalignment angle αₒ assigned or have been otherwise processed, the method continues to step 118 to use at least one of the object misalignment angles αₒ to calculate a cycle misalignment angle α_{c}.

For step 118, at least one object misalignment angle αₒ is used to calculate a cycle misalignment angle α_{c}, and in a preferred embodiment, all of the valid object misalignment angles αₒ calculated in previous method steps are used to calculate the cycle misalignment angle α_{c}. In one embodiment, if multiple object misalignment angles αₒ are used in step 118, an average or a weighted average of all or some of the object misalignment angles αₒ is obtained. For example, a weighting coefficient can be assigned to objects based on certain characteristics. More particularly, it may be desirable to give more weight to stationary objects rather than moving objects. Accordingly, a weighting coefficient such as 4 for each stationary object and 1 for each moving object may be used to calculate a weighted average for the cycle misalignment angle α_{c} (e.g., stationary objects would constitute 80% of the weighted average while moving objects would constitute 20% of the weighted average). In another embodiment, for example, a higher range rate for a moving object could be weighted more than a lower range rate for a moving object. These weighting coefficients are merely exemplary, as other ways to reconcile multiple object misalignment angles αₒ, such as based on confidence level, are certainly possible.

In step 120, which is optional, a long term misalignment angle αₗₜ is established and/or one or more remedial actions may be executed. The long term misalignment angle αₗₜ takes into account misalignment angles (e.g., αₒ or α_{c}) over multiple sensor cycles. One or more object misalignment angles αₒ, one or more cycle misalignment angles α_{c}, or a combination of one or more object and cycle misalignment angles are used to establish a long term misalignment angle αₗₜ. The methodology and algorithms described herein are designed to be iterative and in some cases, recursive, and have a tendency to improve with time and/or with the processing of more valid objects. Accordingly, the establishment of a long term misalignment angle may be desirable. This step may be accomplished in a myriad of different ways. For example, in one embodiment, a moving average is used to calculate the long term misalignment angle αₗₜ. This can be done with either the object misalignment angles αₒ, the cycle misalignment angles α_{c}, or some sort of combination of the two angle types. In a preferred embodiment, the long term misalignment angle αₗₜ is an average of misalignment angles for multiple valid objects over multiple sensor cycles. An example using object misalignment angles αₒ for one or more objects is provided below. If it is assumed that N points are captured or buffered, either from the current sensor cycle and/or previous sensor cycles, and for each point, we compute αₒ for o=1, . . . , N (e.g., for N target objects in one sensor cycle or multiple similar or different target objects over a number of sensor cycles), then the moving average may be calculated as follows:

$${α}_{lt} = \frac{1}{N} {\sum }_{i = 0}^{N - 1} {α}_{o - i}$$

where αₒ is the per object estimation of the misalignment angle and αₗₜ represents the long term average of object misalignment angles αₒ. Other methods of averaging to obtain a long term misalignment angle αₗₜ are certainly possible.

In another embodiment, a digital filter is used to obtain the long term misalignment angle αₗₜ. The digital filter may take a variety of forms. In one example, a first order digital filter, which is essentially an exponential moving average, can be used. An exemplary form for the filter is shown below:

yₖ=m*uₖ+(1−m)*yₖ₋₁

where m is the filter coefficient, uₖ is the filter input (e.g., the cycle misalignment angle α_{c} or the object misalignment angle αₒ), and yₖ₋₁ is the filter output (e.g., the long term misalignment angle αₗₜ). It is also possible for the coefficient m to vary from calculation to calculation and need not be a fixed constant number. In one example, the filter coefficient m is a calibrated parameter that varies depending on the object information, such as how many valid objects are detected in the particular sensor cycle. The usage of a first order digital filter in step 120 has particular benefits. For example, if a moving average is used to establish the long term misalignment angle αₗₜ, N data points need to be stored, but for the first order digital filter, only information pertaining to the last step (yₖ₋₁) is required and there is no need to store N data points.

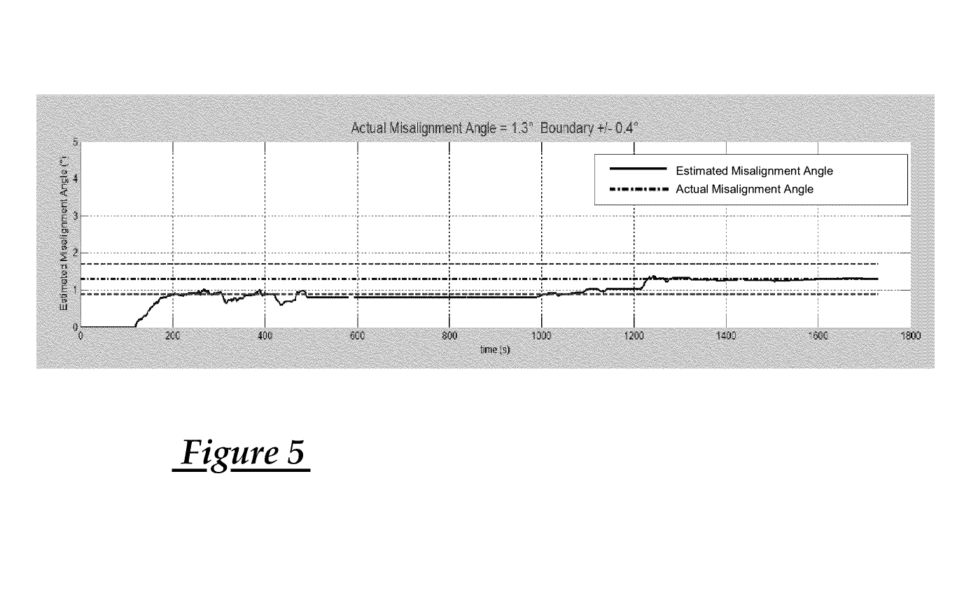

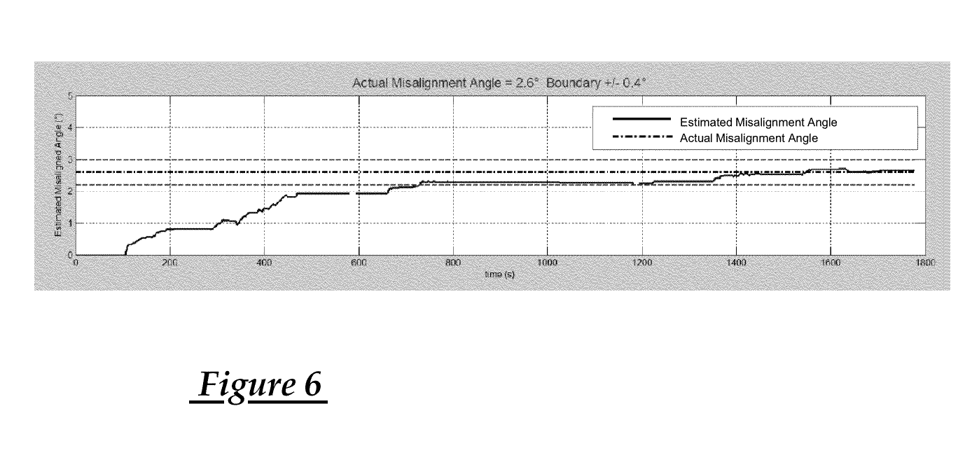

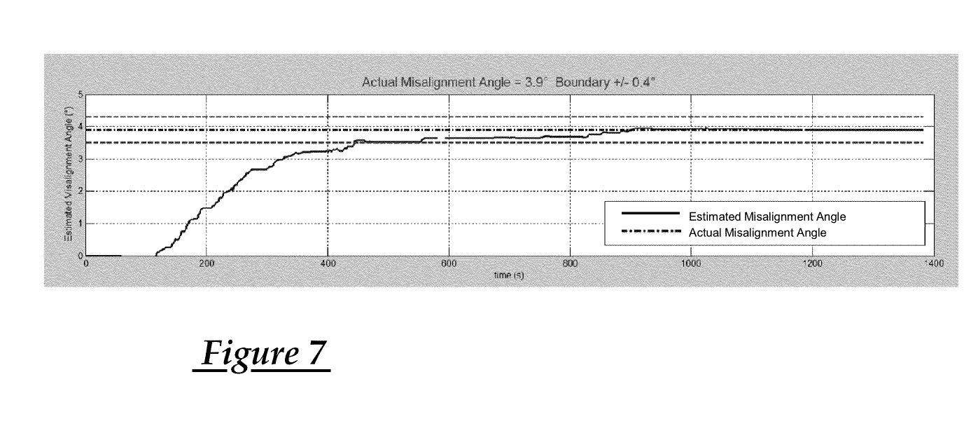

Obtaining a long term misalignment angle αₗₜ may be desirable because of the iterative form of the method, which improves in accuracy as the number of valid objects are processed. FIGS. 5-7 demonstrate actual testing of one embodiment of the system and method described herein. In FIG. 5, the test involved a misaligned object sensor that was 1.3° misaligned or skewed from its intended alignment angle. Within approximately 200 seconds, the estimated long term misalignment angle αₗₜ was within a boundary of +/−0.4° of the actual sensor misalignment. After approximately 1200 seconds, the estimated long term misalignment angle αₗₜ generally coincided with the actual misalignment angle α. In FIG. 6, the test involved a misaligned object sensor that was angled 2.6° from its intended alignment angle. In just over 700 seconds, the estimated misalignment angle was within a boundary of +/−0.4°. At around 1350 seconds, the estimated long term misalignment angle αₗₜ generally coincided with the actual misalignment angle α. In FIG. 7, the test involved an object sensor with an actual misalignment of 3.9° from its intended alignment angle. Within approximately 450 seconds, the estimated long term misalignment angle αₗₜ was within a boundary of +/−0.4°. After approximately 900 seconds, the long term misalignment angle αₗₜ generally coincided with the actual misalignment angle α.

In one implementation of step 120, one or more remedial actions may be taken, which can be important when information from the object sensor is used in other vehicle systems, particularly with active safety systems. The decision of whether or not to execute a remedial action may be based on a number of factors, and in one example, may involve comparing an angular misalignment estimation, αₒ, α_{c}, or αₗₜ, or any combination thereof to a threshold (e.g., 3-5°). In a more particular example, the threshold may be a calibrated parameter. In another example, the decision may be based on whether a certain threshold number of valid objects have been analyzed. Remedial actions may include compensating for the angular misalignment, which may be based on αₒ, α_{c}, αₗₜ, or any combination or average of the angular misalignment estimation; sending a warning message to the driver via user interface 50, to some other part of the host vehicle like module 60, or to a remotely located back-end facility (not shown); setting a sensor fault flag or establishing a diagnostic trouble code (DTC); or disabling some other device, module, system and/or feature in the host vehicle that depends on the sensor readings from the misaligned object sensor for proper operation, to cite a few possibilities. In one embodiment, an angular misalignment is compensated for by adding the estimated angular misalignment value to a measured azimuth. In another embodiment, step 120 sends a warning message to user interface 50 informing the driver that object sensor 30 is misaligned and sends command signals to module 60 instructing the module to avoid using sensor readings from the misaligned or skewed object sensor until it can be fixed. Other types and combinations of remedial actions are certainly possible.

The exemplary method described herein may be embodied in a lightweight algorithm that is less memory- and processor-intensive than previous methods that gather and analyze large collections of data points. For example, use of a first order digital filter to establish a long-term estimated misalignment angle can reduce the memory- and processor-related burdens on the system. These algorithmic efficiencies enable method 100 to be executed or run while host vehicle 10 is being driven, as opposed to placing the sensor in an alignment mode and driving with a predefined route or requiring that the host vehicle be brought to a service station and examined with specialized diagnostic tools. Furthermore, it is not necessary for host vehicle 10 to utilize high-cost object sensors that internally calculate over a number of sensor cycles or to require multiple object sensors with overlapping fields-of-view, as some systems require.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, the specific combination and order of steps is just one possibility, as the present method may include a combination of steps that has fewer, greater or different steps than that shown here. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method for determining misalignment of an object sensor on a host vehicle, comprising the steps of:
determining if the host vehicle is traveling in a straight line;
receiving object sensor readings from the object sensor, and obtaining object parameters from the object sensor readings for at least one object in the object sensor field of view;
when the host vehicle is traveling in a straight line, using the object parameters to calculate an object misalignment angle αₒ between an object axis and a sensor axis for the at least one object; and
using the object misalignment angle αₒ to determine a sensor misalignment angle α.

2. The method of claim 1, wherein the step of determining if the host vehicle is traveling in a straight line further comprises receiving vehicle sensor readings from at least one of a yaw rate sensor, a wheel speed sensor, or a steering angle sensor, and using the vehicle sensor readings to determine if the host vehicle is traveling in a straight line.

3. The method of claim 1, wherein the step of determining if the host vehicle is traveling in a straight line further comprises determining if a turn signal switch is activated, and using the activation status of the turn signal switch to determine if the host vehicle is traveling in a straight line.

4. The method of claim 1, wherein the object parameters include a coordinate and a coordinate rate for the at least one object.

5. The method of claim 4, wherein the coordinate comprises a range from the host vehicle to the at least one object and an azimuth between the sensor axis and the direction of the at least one object, and the coordinate rate comprises a rate of change of the range and of the azimuth.

6. The method of claim 4, wherein the coordinate comprises an X axis position for the at least one object and a Y axis position for the at least one object, and the coordinate rate comprises a rate of change of the position.

7. The method of claim 5, wherein the following equation is used to calculate the object misalignment angle αₒ:
$${α}_{o} = a tan ( - \frac{\dot{r} sin θ + r cos θ \dot{θ}}{\dot{r} cos θ - r sin θ \dot{θ}} )$$

8. The method of claim 1, wherein the at least one object includes one or more moving objects and one or more stationary objects.

9. The method of claim 1, wherein a plurality of object misalignment angles αₒ are used to determine a cycle misalignment angle α_{c}, and the cycle misalignment angle α_{c} is used to determine the sensor misalignment angle α.

10. The method of claim 9, wherein stationary objects are weighted in favor of moving objects when determining the cycle misalignment angle α_{c}.

11. The method of claim 9, wherein the object misalignment angle αₒ, the cycle misalignment angle α_{c}, or both the object misalignment angle αₒ and the cycle misalignment angle α_{c} are used to determine a long term misalignment angle αₗₜ, and the long term misalignment angle αₗₜ is used to determine the sensor misalignment angle α.

12. The method of claim 11, wherein a moving average is used to determine the long term misalignment angle αₗₜ.

13. The method of claim 11, wherein a first order digital filter is used to determine the long term misalignment angle αₗₜ.

14. The method of claim 13, wherein a filter coefficient of the first order digital filter is a calibrated parameter that varies depending on the number of valid objects analyzed in a particular sensor cycle.

15. The method of claim 11, wherein one or more of the following remedial actions are executed based on the long term misalignment angle αₗₜ: compensating for the sensor misalignment angle α, sending a warning message regarding the sensor misalignment angle α, establishing a diagnostic trouble code (DTC) representative of the sensor misalignment angle α, or disabling a device, module, system and/or feature of the host vehicle based on the sensor misalignment angle α.

16. The method of claim 1, wherein the sensor misalignment angle α is determined while the host vehicle is being driven and without the need for multiple object sensors with overlapping fields of view.

17. A method for determining misalignment of an object sensor on a host vehicle, comprising the steps of:
determining if the host vehicle is traveling in a straight line;
receiving object sensor readings from the object sensor, and obtaining object parameters from the object sensor readings for at least one object in the object sensor field of view;
determining if the at least one object is a valid object;
when the host vehicle is traveling in a straight line and the at least one object is a valid object, using the object parameters to calculate an object misalignment angle αₒ between an object axis and a sensor axis for the at least one valid object;
using the object misalignment angle αₒ to establish a long term misalignment angle αₗₜ; and
using the long term misalignment angle αₗₜ to determine a sensor misalignment angle α.

18. The method of claim 17, wherein the step of determining if the at least one object is a valid object is includes comparing a range rate of the object to a range rate threshold.

19. The method of claim 17, wherein the step of determining if the at least one object is a valid object is includes implementing a reduced field of view for the object sensor comprising an angular threshold, a distance threshold, or both an angular threshold and a distance threshold.

20. The method of claim 19, wherein the distance threshold is determined by comparing a road curvature radius to a road curvature radius threshold.

21. A vehicle system on a host vehicle, comprising:
one or more vehicle sensors providing vehicle sensor readings, the vehicle sensor readings indicate whether or not the host vehicle is traveling in a straight line;
one or more object sensors providing object sensor readings, wherein the object sensor readings include object parameters for at least one object in an object sensor field of view; and
a control module being coupled to the one or more vehicle sensors for receiving the vehicle sensor readings and being coupled to the one or more object sensors for receiving the object sensor readings, wherein the control module is configured to use the object parameters to calculate an object misalignment angle αₒ for the at least one object, the object misalignment angle αₒ being defined by an object axis and a sensor axis, and using the object misalignment angle αₒ to determine a sensor misalignment angle α.
